(19) United States
(12) Patent Application Publication
(10) Pub. No.: US 2010/0162358 A1
(43) Pub. Date: Jun. 24, 2010

(54) Media Processing Device For Providing Access To Images In Remote Databases And Method Thereof

(76) Inventors: Edward Barsikh Ghazalian, Cynthiana, KY (US); Bruce Alan Harney, Lexington, KY (US); Lyle Bruce McMillin, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/339,697

(22) Filed: Dec. 19, 2008

(51) Int. Cl. G06F 17/30; G06F 21/00; G06F 3/048

(52) U.S. Cl. 726/3; 715/810; 707/E17.019

(57) ABSTRACT

Disclosed are a media processing device for providing access to images in a remote database and a method thereof. The media processing device includes an input module, a transceiver module and a user interface module. The input module is configured to receive an input from a user. The transceiver module is communicably coupled to a remote database for transmitting the input to the remote database and receiving one or more images from the remote database based on the input. The user interface module is configured to display at least one image of the one or more images to the user.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to media processing devices, and, more particularly, to a media processing device for providing access to images in remote databases.

2. Description of the Related Art

Media processing devices, such as printers and plotters, are typically used to output information displayed on a screen of a data processing device, such as a personal computer. The information may be output on a media sheet, such as a sheet of paper. Outputting the information on the media sheet, also known as printing the information onto the media sheet, refers to placing discrete units of colorants, such as ink droplets, on the media sheet corresponding to the information to be printed on the media sheet. The information printed on the media sheet may include text, graphics, images or any combination thereof.

The data processing device is typically configured to display the information on the screen for enabling a user of the data processing device to view the information prior to printing the information on the media sheet. The data processing device may also enable the user to search the information prior to printing the information on the media sheet. The information may be stored in a local memory in the data processing device, such as a Random Access Memory (RAM) or a Read Access Memory (ROM), or may be requested from a remote repository storing the information, such as a remote database server.

In corporations and business organizations, the media processing device is typically installed in combination with the data processing device for enabling employees to print the desired information on media sheets. Installing the data processing device and the media processing device may be unsuitable for certain industries, such as utilities industries, where a substantial portion of work may be performed by field crews dispersed over a geographical area. Examples of utilities industries may include industries such as the communication industry, the power supply industry, the water supply industry and the like. Moreover, activities performed by the field crews of the utilities industries may include use of the information, such as schematics, engineering drawings and maps. The field crews may need to retrieve the information, and, may need to view the information prior to printing the information on the media sheet.

However, setting up data processing devices and the media processing devices at an onsite location, such as an electric power plant, for printing the information on the media sheets may be cumbersome and uneconomical. Further, the field crews at onsite locations may not be proficient in utilizing the data processing devices, due to a lack of training of the field crews on using the data processing devices or due to the inherent complexity of operations to be performed on the data processing devices.

Based on the foregoing, there is a need for providing access to the information at the onsite locations in a convenient and cost effective manner. More specifically, access to the images, such as schematics, engineering drawings and maps, located in remote databases needs to be provided at the onsite locations. Further, there exists a need to enable a user to view the information at the onsite locations for printing the information on the media sheet, while precluding the setting up of expensive data processing devices. Furthermore, there is need for providing access to the information with minimal complexity and without requiring user expertise for accessing the information.

### SUMMARY OF THE DISCLOSURE

In view of the foregoing disadvantages inherent in the prior art, the general purpose of the present disclosure is to provide a media processing device for providing access to images in a remote database and a method thereof, to include all the advantages of the prior art, and to overcome the drawbacks inherent therein.

Accordingly, in one aspect, the present disclosure provides a media processing device for providing access to images in a remote database. The media processing device includes an input module, a transceiver module and a user interface module. The input module is configured to receive an input from a user. The transceiver module is communicably coupled to a remote database for transmitting the input to the remote database. Further, the transceiver module is capable of receiving one or more images from the remote database based on the input. The user interface module is configured to display at least one image of the one or more images to the user.

Further, in another aspect, the present disclosure provides a method for providing access to images in a remote database by a media processing device. The method includes receiving input from a user of the media processing device. The input is transmitted to the remote database. Further, one or more images are received from the remote database based on the transmitted input. At least one image of the one or more images is displayed to the user, thereby providing access to the images in the remote database by the media processing device.

The media processing device may be deployed at onsite locations and may further be configured to print the at least one image. The media processing device is configured to enable a user to view a list of the one or more images for selecting the at least one image for printing the information on the media sheet. On selection of the at least one image from the list of the one or more images, the user may view the at least one image prior to printing the at least one image. Thus, the media processing device precludes the need of installing expensive data processing devices at the onsite locations thereby providing access to the information at the onsite locations in a convenient and cost effective manner. More specifically, the media processing device provides access to the images, such as schematics, engineering drawings and maps that are located in remote databases, for users at the onsite locations. Furthermore, the media processing device provides access to the information, such as the at least one image, with minimal complexity and without requiring user expertise for accessing the information.

### BRIEF DESCRIPTION OF THE DRAWINGS

The above-mentioned and other features and advantages of the present disclosure, and the manner of attaining them, will become more apparent and the present disclosure will be better understood by reference to the following description of embodiments of the present disclosure taken in conjunction with the accompanying drawings, wherein:

FIG. 1 depicts a schematic diagram of an environment in which various embodiments of the present disclosure may be practiced;

FIG. 2 is a block diagram of a media processing device, in accordance with an embodiment of the present disclosure;

FIG. 3 is a flow diagram depicting a method for providing access to images in a remote database by a media processing device, in accordance with an embodiment of the present disclosure;

FIG. 4 is a flow diagram depicting a method exemplifying the method explained in conjunction with FIG. 3 for providing access to the images in the remote database by the media processing device;

FIG. 5 is a flow diagram depicting another method exemplifying the method explained in conjunction with FIG. 3 for providing access to the images in the remote database by the media processing device; and

FIGS. 6A and 6B depict an exemplary user interface module of the media processing device explained in conjunction with FIG. 2, in accordance with an embodiment of the present disclosure.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections and couplings. In addition, the terms “connected” and “coupled” and variations thereof are not restricted to physical or mechanical connections or couplings.

In addition, it should be understood that embodiments of the present disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the present disclosure may be implemented in software. As such, it should be noted that a plurality of hardware and software-based devices, as well as a plurality of different structural components may be utilized to implement the present disclosure.

The present disclosure provides a media processing device for providing access to images in a remote database and a method thereof. An input is received from a user of the media processing device. The input is transmitted to the remote database. Further, one or more images are received from the remote database based on the transmitted input. At least one image of the one or more images is displayed to the user, thereby providing access to the images in the remote database by the media processing device.

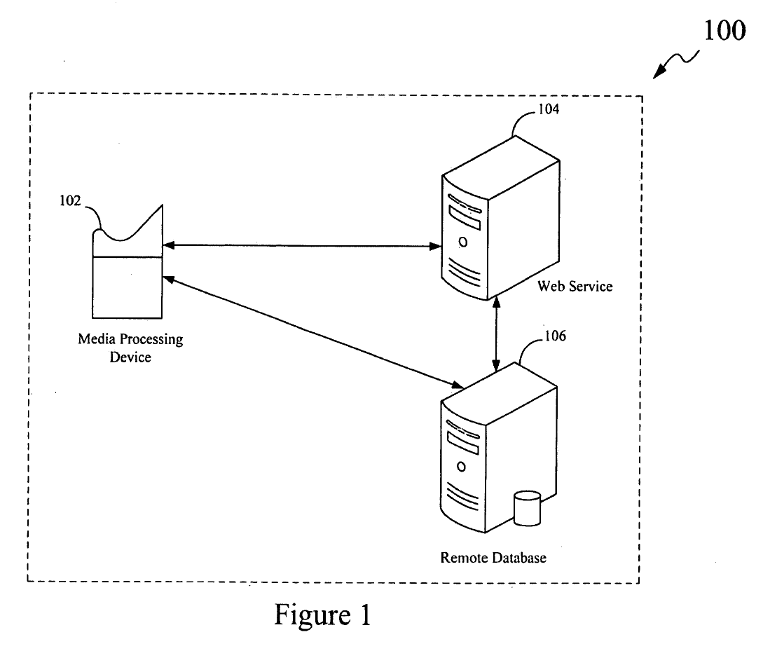

Referring now to the drawings and particularly to FIG. 1, there is shown a schematic diagram of an environment 100 in which various embodiments of the present disclosure may be practiced. Environment 100 includes a media processing device 102, a web service 104 and a remote database 106. Media processing device 102 is communicably coupled to remote database 106 for accessing images stored in remote database 106. Examples of the images stored in remote database 106 may include, but are not limited to, maps, engineering drawings and schematics. Media processing device 102 may communicate with remote database 106 using a wired network, a wireless network or a combination thereof.

As shown in FIG. 1, media processing device 102 may also be communicably coupled to remote database 106 through web service 104. Media processing device 102 may communicate with web service 104 using the wired network, the wireless network or a combination thereof. Similarly, web service 104 may communicate with remote database 106 using the wired network, the wireless network or a combination thereof. Examples of the wired network may include, but are not limited to, Local Area Network (LAN) and Wide Area Network (WAN). Examples of wireless network may include a Wireless Local Area Network (WLAN), a cellular network and the like.

It will be evident to those skilled in the art that media processing device 102, web service 104 and remote database 106 may be located at different physical locations. For instance, media processing device 102 may be located at an onsite location, such as an electric power plant; web service 104 may be a web-based application housed in an Internet server; and, remote database 106 may be a repository of images stored in a database server. Moreover, it will be obvious to a person skilled in the art that though FIG. 1 is shown to depict media processing device 102 as communicably coupled to remote database 106, media processing device 102 may be communicably coupled to a plurality of remote databases similar to remote database 106 for accessing the images. In an embodiment of the present disclosure, web service 104 manages access to the plurality of remote databases by media processing device 102.

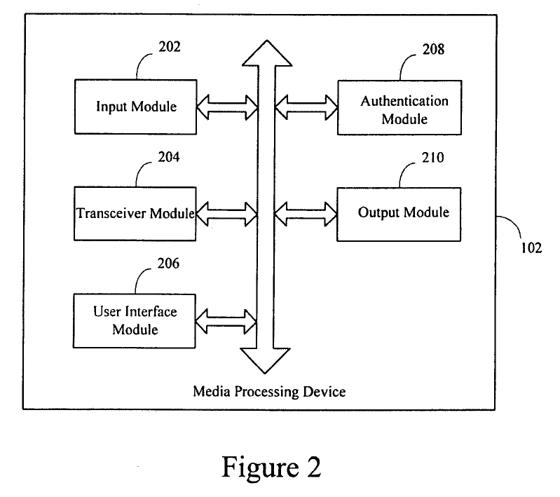

A user may utilize media processing device 102 for accessing the images stored in remote database 106. Users may provide an input, such as identification information to media processing device 102. Media processing device 102 may transmit the input to remote database 106. Remote database 106 may transmit the one or more images to media processing device 102 based on the input. Media processing device 102 may then display at least one image of the one or more images to the user. Media processing device 102 and various components of media processing device 102 for providing access to the images in remote database 106 will be explained in conjunction with FIG. 2.

FIG. 2 depicts a block diagram of media processing device 102, in accordance with an embodiment of the present disclosure. Media processing device 102 includes an input module 202, a transceiver module 204, a user interface module 206, an authentication module 208 and an output module 210. Input module 202 is capable of receiving an input from a user. Examples of input module 202 include a keyboard, a mouse, a joystick, a touch screen, and the like.

For the purpose of description of the present disclosure, the input may be identification information capable of uniquely identifying the user of media processing device 102. Examples of the identification information include user name, password, and the like. Each user of media processing device 102 is associated with corresponding identification information that uniquely identifies the user. The identification information of users of media processing device 102 may be stored in a local memory, such as a Random Access Memory (RAM) or Read Only Memory (ROM), in media processing device 102. The identification information of the users may also be stored at web service 104 or remote database 106. Further, the identification information corresponding to each user is associated with one or more images. The one or more images associated with the identification information of the user may be stored in remote database 106, as explained in FIG. 1. The user may provide the identification information as the input to media processing device 102.

In an embodiment of the present disclosure, input module 202 is also configured to receive image information associated with an image of the one or more images, along with the input. The image information may include a name of the image, identification (ID) of the image, a partial name of the image, and the like. Input module 202 may provide the received input to the authentication module 208 for verifying the authenticity of the user of media processing device 102.

Authentication module 208 is configured to authenticate the user based on the input. Authentication module 208 may authenticate the user by comparing the input provided by the user with the identification information of the user stored in a local memory (not shown) for a match. The local memory may include the identification information of the users of media processing device 102. Authentication module 208 may be configured to authenticate the user prior to transmission of the input to the remote database by transceiver module 204.

Transceiver module 204 is communicably coupled to remote database 106 for transmitting the input to remote database 106. Remote database 106 includes the one or more images for which access is desired by the user of media processing device 102. Remote database 106 further includes the identification information of the users of media processing device 102. Furthermore, remote database 106 may also include information associating the one or more images to the identification information of each user of the users of media processing device 102.

In an embodiment of the present disclosure, transceiver module 204 transmits the input to the web service 104 for transmitting the input to remote database 106. Web service 104 is capable of managing access to remote database 106. In another embodiment of the present disclosure, transceiver module 204 is also configured to transmit the image information received along with the input to one of web service 104 and remote database 106.

Further, transceiver module 204 is configured to receive the one or more images from remote database 106 based on the input. In an embodiment of the present disclosure, web service 104 may be configured to retrieve the one or more images from remote database 106, based on the input from the user. Further, web service 104 may transmit the one or more images to transceiver module 204.

Each image of the one or more images may be associated with at least one memory location. The at least one memory location of the each image facilitates in retrieving the each image from remote database 106. It will be apparent to a person skilled in the art that the at least one memory location for an image may correspond to multiple memory locations in remote database 106 for the image, or the at least one memory location may correspond to memory locations of partial images forming the image. Web service 104 may include information of the at least one memory location of at least one image of the one or more images. The at least one memory location may be a memory address of the at least one image in remote database 106. The at least one memory location may also be a memory pointer providing location information of the at least one image in remote database 106. In an embodiment of the present disclosure, an image information of an image received along with the input from the user may be utilized by transceiver module 204 to receive the at least one memory location of the image. Furthermore, web service 104 may transmit the at least one memory location to transceiver module 204. Transceiver module 204 may receive the at least one memory location from web service 104 and transmit the at least one memory location to remote database 106 for receiving the at least one image associated with the at least one memory location from remote database 106.

Transceiver module 204 is communicably coupled to user interface module 206. User interface module 206 is capable of displaying the at least one image of the one or more images to the user. Examples of user interface module 206 include a Cathode Ray Tube (CRT) monitor, a flat panel display monitor, a Liquid Crystal Display (LCD) monitor, and the like. In an embodiment of the present disclosure, user interface module 206 is configured to display a list of the one or more images received from remote database 106 to the user. Each entry of the list may be associated with an image of the one or more images. Further, each entry of the list may include the information of the image, such as name of the image, thumbnail of the image, size of the image, ID of the image, and the like.

The user may select at least one image of the one or more images from the list. Input module 202 may be configured to receive a user selection of the at least one image from the list for displaying the at least one image to the user. User interface module 206 may display the at least one image to the user based on the user selection. The user may print the at least one image displayed on user interface module 206. Input module 202 may be configured to receive a print command signal from the user. Further, output module 210 may be configured to print the at least one image, based on the print command signal received by the input module 202.

In an embodiment of the present disclosure, the at least one image selected by the user for displaying may be smaller in size than, larger in size than or equal to a pre-defined threshold size. Alternatively, the image for which the image information is received from the user along with the input, may be smaller, equal or larger in size than the pre-defined threshold size. In an embodiment of the present disclosure, the pre-defined threshold size may be 11×17 square inches. Remote database 106 may be capable of storing an image of the one or more images as a plurality of partial images when a size of the image is greater than the pre-defined threshold size.

Each partial image of the plurality of partial images may include a part of the image that is greater than the pre-defined threshold size (such an image is hereinafter referred to as ‘large image’). Further, the plurality of partial images may form the large image when combined together. For example, a large image of size 22×34 square inches may be stored in remote database 106 as four partial images of size 11×17 square inches each, such that when the four partial images are combined together, the large image may be formed.

When the at least one image selected by the user is a large image, transceiver module 204 is capable of receiving the plurality of partial images associated with the large image from remote database 106. User interface module 206 is configured to display the plurality of partial images to the user. The user may select a partial image of the plurality of partial images. Input module 202 may be configured to receive an image selection of the partial image from the user. For example, the user may use a mouse pointer to select a partial image of the plurality of partial images.

User interface module 206 may be configured to then display the partial image to the user based on the image selection received from the user. Output module 210 may be configured to print the partial image displayed on user interface 206. Output module 210 may print the partial image, based on the print command received by input module 202 from the user.

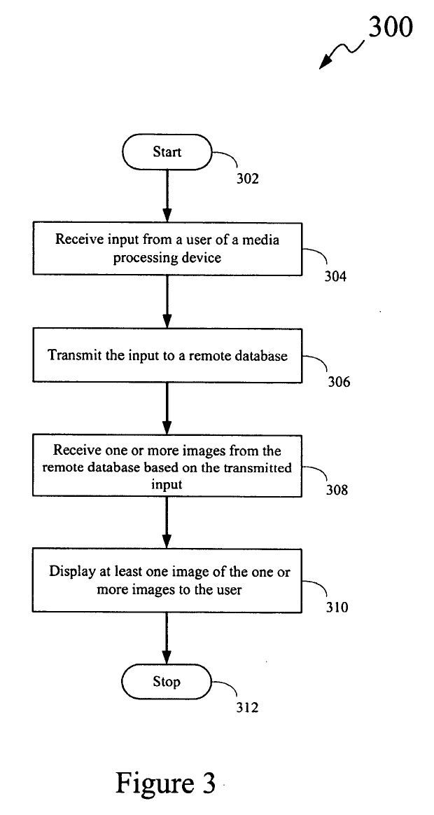

It will be apparent to a person skilled in the art that each component of media processing device 102, such as input module 202, transceiver module 204, user interface module 206, authentication module 208, output module 210 and the local memory may be implemented as a hardware module, a software module, a firmware modules, or any combination thereof. Further, it will be obvious to those skilled in the art that media processing device 102 may include requisite electrical connections or other connections for communicably coupling the various components of media processing device 102. Furthermore, it will be evident to those skilled in the art that media processing device 102 may include typical components (not shown), such as an input media tray, a printing mechanism including one or more printing cartridges, drive rolls for driving media sheet in media processing device 102 and one or more motors for driving the drive rolls, a battery unit and a microprocessor for performing typical functions of media processing device 102. A method for providing access to the images in remote database 106 by a media processing device, such as media processing device 102, is explained in conjunction with FIG. 3.

FIG. 3 is a flow diagram depicting a method 300 for providing access to images in a remote database, such as remote database 106, by a media processing device, such as media processing device 102, in accordance with an embodiment of the present disclosure. Method 300 begins at 302. At 304, an input is received from a user of the media processing device. At 306, the input is transmitted to the remote database. At 308, one or more images are received from the remote database based on the transmitted input. At 310, at least one image of the one or more images is displayed to the user. Method 300 ends at 312. At 312, the at least one image displayed may be printed on a media sheet by the media processing device on receiving a print command signal from the user.

In an embodiment of the present disclosure, the user is authenticated based on the input prior to transmission of the input to the remote database. As explained in conjunction with FIG. 2, the input may include identification information uniquely identifying the user. Examples of the identification information may include a username, a password, and the like. The media processing device may compare the received input with the identification information of the user stored in a local memory, such as a RAM or ROM, of the media processing device for a match. On occurrence of a match between the received input and the identification information of the user stored in the local memory, the media processing device may then transmit the input to the remote database for receiving the one or more images.

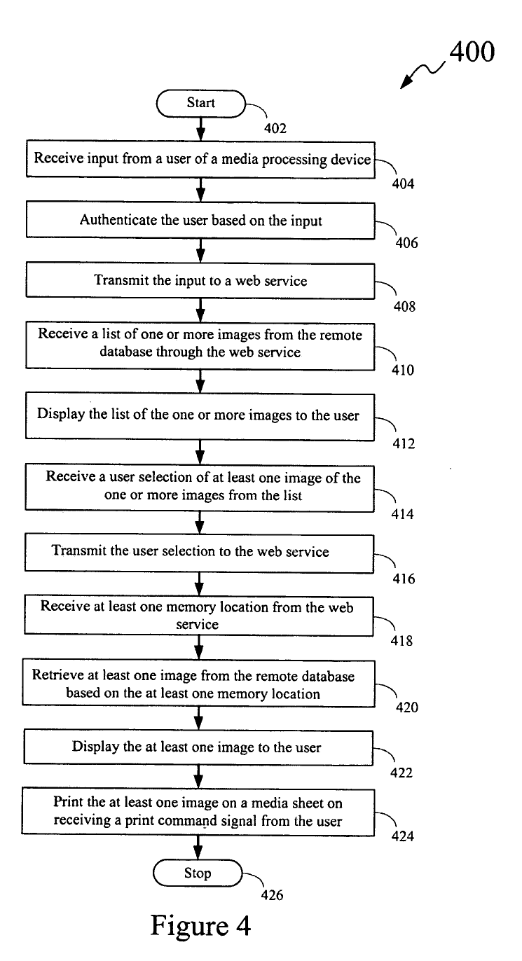

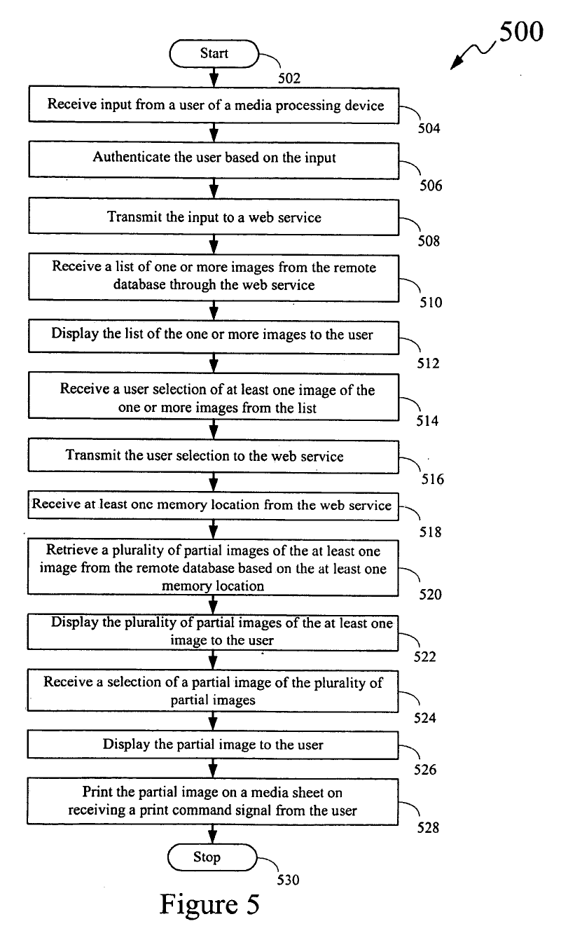

The input may be transmitted to the remote database using a wired network, such as LAN, or a wireless network, such as a Wireless LAN (WLAN), or a combination thereof. The remote database may include the one or more images, for which access is desired by the user of the media processing device. Examples of an image of the one or more images may include a map, an engineering drawing, a schematic and the like. The remote database may further include the identification information of each user of the media processing device. The remote database also includes information associating images with the corresponding identification information of the each user. On receiving the input from the media processing device, the remote database may transmit the one or more images associated with the identification information included in the input, to the media processing device. The media processing device may then display at least one image of the one or more images received from the remote database to the user, thereby providing access to the images in the remote database. The user may then view the at least one image and print the at least one image using the print command signal. One or more variations of method 300 may be contemplated for providing access to the images in the remote database by the media processing device without departing from the scope of the present disclosure. FIG. 4 and FIG. 5 depict such exemplary embodiments of the method 300 for providing access to the images in the remote database by the media processing device.

FIG. 4 is a flow diagram depicting a method 400 exemplifying method 300 for providing access to the images in the remote database by the media processing device. The method starts at 402. At 404, the input from the user is received by the media processing device. At 406, the user is authenticated by the media processing device. At 408, the input is transmitted to a web service, such as web service 104. The web service transmits the input to the remote-database for receiving the one or more images from the remote database based on the input. The web service then transmits a list of the one or more images to the media processing device. At 410, the list of one or more images is received by the media processing device from the remote database through the web service. At 412, the media processing device displays the list of the one or more images to the user. At 414, the media processing device receives a user selection of at least one image of the one or more images displayed in the list from the user. At 416, the media processing device transmits the user selection to the web service. At 418, the media processing device receives at least one memory location of the at least one image from the web service. At 420, the media processing device retrieves the at least one image from the remote database using the at least one memory location. At 422, the at least one image is displayed by the media processing device to the user. At 424, the at least one image is printed by the media processing device on receiving a print command signal from the user. Method 400 ends at 426.

As explained in conjunction with FIGS. 2 and 3, the input received by the media processing device may include identification information that uniquely identifies the user. The media processing device may authenticate the user by comparing the input with the identification information stored in the local memory for a match. On authenticating the user, the media processing device may transmit the input to the web service using a transceiver module, such as the transceiver module 204. The web service is configured to retrieve the one or more images associated with the identification information of the user from the remote database based on the input. More specifically, information of the one or more images, such as name of image, size of image, type of image, and the like, is retrieved from the remote database by the web service. For example, the input that includes the identification information of the user may be associated with five images. The information of the five images may be retrieved from the remote database by the web service. The information of the one or more images may be received by the media processing device from the remote database through the web service, based on the input transmitted. The information of the one or more images may be displayed to the user in form of the list of the one or more images.

As described previously in conjunction with FIG. 2, each entry of the list may be associated with an image of the one or more images. Further, the each entry of the list may include the information of the associated image, such as name of the image, thumbnail of the image, size of the image, ID of the image, and the like. In an embodiment of the present disclosure, the each entry of the list may include a thumbnail image of the associated image.

Further, the user may select at least one image of the one or more images from the list for display purposes. A user selection of the at least one image may be received from the user by the media processing device. It will be apparent to a person skilled in the art that the user selection may be received through keystroke entries on a keyboard, mouse clicks of a mouse, joystick movement on a joystick, user touch on a touch screen display, and the like.

The at least one image received as the user selection from the user may be transmitted to the web service. The web service may receive at least one memory location of the at least image from the remote database. As explained previously, the at least one memory location may be a memory address of the remote database. The at least one memory location may also be a memory pointer. In an embodiment of the present disclosure, the at least one memory location may correspond to the image for which the information was provided along with the input by the user.

The web service may transmit the at least one memory location to the media processing device. Further, the at least one memory location may be transmitted by the media processing device to the remote database. The at least one image may be received from the remote database by the media processing device, based on the at least one memory location. The at least one image may then be displayed to the user by the media processing device. In an embodiment of the present disclosure, a thumbnail of the at least one image may be displayed to the user. The user may then click on the thumbnail for viewing the at least one image. Further, the user may be enabled to print the at least one image by the media processing device. A print command signal may be received from the user for printing the at least one image on a media sheet.

In an embodiment of the present disclosure, the at least one image selected by the user may be of a size greater than a pre-defined threshold size. The method for displaying images greater than the pre-defined threshold size is explained in conjunction with FIG. 5.

FIG. 5 is a flow diagram depicting another method 500 exemplifying method 300 for providing access to the images in the remote database by the media processing device. The method starts at 502. At 504, the media processing device receives the input from the user. At 506, the user is authenticated by the media processing device. At 508, the input is transmitted to the web service. The web service transmits the input to the remote database for receiving the one or more images from the remote database based on the input. The web service then transmits a list of the one or more images to the media processing device. At 510, the list of the one or more images is received by the media processing device from the remote database through the web service. At 512, the media processing device displays the list of the one or more images to the user. At 514, the media processing device receives a user selection of at least one image of the one or more images displayed in the list of the one or more images. At 516, the media processing device transmits the user selection to the web service. At 518, the media processing device receives at least one memory location of the at least one image from the web service. For a size of the at least one image greater than a pre-defined threshold size, the at least one image is stored as a plurality of partial images in the remote database. At 520, the media processing device retrieves the plurality of partial images of the at least one image from the remote database using the at least one memory location. At 522, the plurality of partial images is displayed by the media processing device to the user. At 524, a selection of a partial image of the plurality of partial images is received by the media processing device from the user. At 526, the partial image of the plurality of partial images is displayed to the user by the media processing device. At 528, the partial image is printed on a media sheet by the media processing device on receiving a print command signal from the user. Method 500 ends at 530.

It will be evident to those skilled in the art that the pre-defined threshold size may be based on specific configurations, such as maximum printable size, defined for the media processing device. In an embodiment of the present disclosure, the pre-defined threshold size may be 11×17 square inches. The at least one image with size greater than the pre-defined threshold size (such an image is hereinafter referred to as a ‘large image’) may be stored in the remote database as the plurality of partial images. As explained previously in conjunction with FIG. 2, each partial image of the plurality of partial images may include a part of the large image. Further, the plurality of partial images may form the large image when combined together. For example, a large image of size 20×20 square inches may be stored in the remote database as four partial images of sizes 11×17 square inches, 11×3 square inches, 9×17 square inches and 9×3 square inches. Further, when the four partial images are combined together, the large image may be formed. It will be apparent to a person skilled in the art that the user may provide the information of the large image along with the input. Alternatively, the large image may be the at least one image selected by the user.

In an embodiment of the present disclosure, the at least one memory location includes memory locations corresponding to the plurality of partial images when the at least one image received as the user selection is the large image. Further, each of the plurality of partial images may be received from the remote database by the media processing device, based on the at least one memory location of the plurality of partial images.

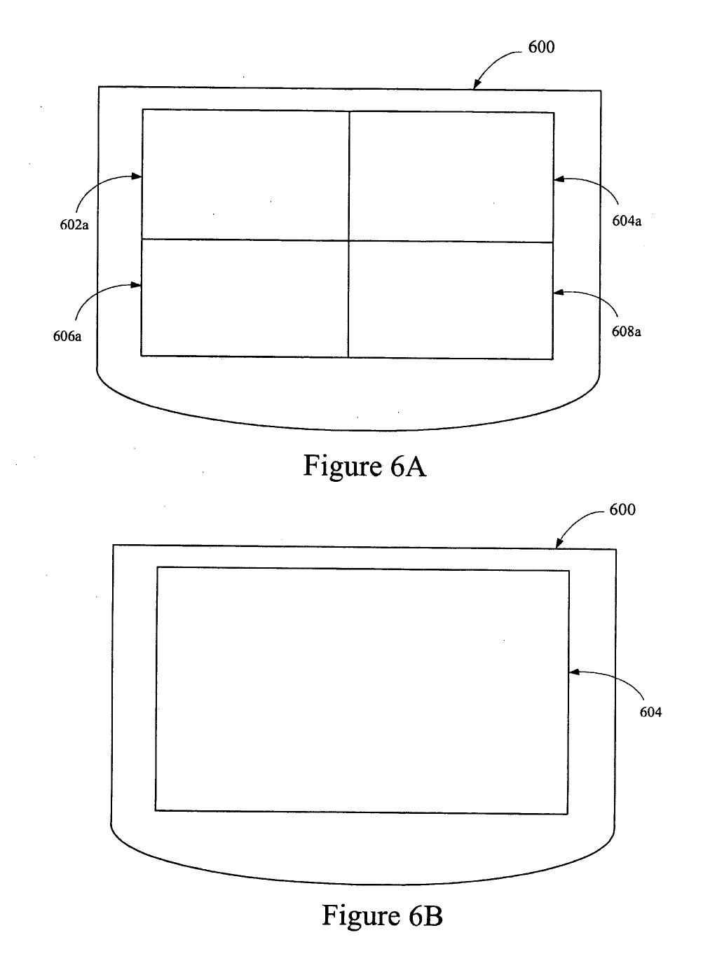

Furthermore, the plurality of partial images received by the media processing device may be displayed to the user. The user may select a partial image of the plurality of partial images. The media processing device may receive an image selection of the partial image from the user. It will be apparent to a person skilled in the art that the media processing device may receive the image selection of the partial image through a mouse click of a mouse, keystrokes on, a keyboard, movement on a joystick, user touch on a touch screen display, and the like. Further, a partial image of the plurality of partial images may be displayed to the user and printed based on the print command signal received from the user, as explained in conjunction with FIGS. 2 and 4. Screenshots of a display screen exemplifying user interface module 206 explained in conjunction with FIG. 2 for displaying the plurality of partial images and a partial image of the plurality of partial image is explained in conjunction with FIGS. 6A and 6B respectively.

FIGS. 6A and 6B depict screenshots of display screen 600 exemplifying user interface module 206, explained in conjunction with FIG. 2, for displaying thumbnails of a plurality of partial images that form a large image and for displaying a partial image of the plurality of partial images respectively, in accordance with an embodiment of the present disclosure.

In FIG. 6A, the display screen 600 displays four thumbnails of the plurality of partial images that include a partial image thumbnail 602a, a partial image thumbnail 604a, a partial image thumbnail 606a and a partial image thumbnail 608a. The thumbnails of the plurality of partial images such as partial image thumbnails 602a, 604a, 606a and 608a, correspond to the plurality of partial images that combine to form an image of size greater than the pre-defined threshold size for the media processing device (such an image is hereinafter referred to as ‘large image’). As explained in conjunction with FIGS. 2 and 5, when the user selects a large image from the list of one or more images displayed to the user, the media processing device receives the plurality of partial images (that collectively form the large image) from the remote database. The thumbnails of the plurality of partial images may then be displayed to the user as depicted in FIG. 6A.

The user may then select a partial image thumbnail, such as partial image thumbnail 604a, for viewing a magnified partial image corresponding to the selected partial image thumbnail. In FIG. 6B, a partial image corresponding to partial image thumbnail 604a is displayed to the user on selection of partial image thumbnail 604a by the user. The user may thus zoom in to a selected region defined by a partial image of the plurality of partial images by selecting the partial image thumbnail corresponding to the selected region.

In an embodiment of the present disclosure, the media processing device may receive the plurality of partial images from the remote database based on the image information of the large image provided along with the input to the remote database.

In another embodiment of the present disclosure, the media processing device receives at least one memory location of the large image from the remote database on selection of the large image by the user. The at least one memory location of the large image may include memory locations of the plurality of partial images. The at least one memory location may correspond to the thumbnails of the plurality of partial images. Each thumbnail of the thumbnails may be associated with a partial image of the plurality of partial images.

In an embodiment of the present disclosure, each large image (of size greater than the pre-defined threshold size of 11×17 square inches) is stored in the remote database as a number of images given by a formula:

3n+1,

where ‘n’ represents the number of partial images required to configure the large image. The ‘3n’ in the formula corresponds to three versions, namely—a thumbnail version (‘n’ number of partial images of the thumbnail version) of the partial image, a magnified version (‘n’ number of partial images of the magnified version) capable of completely occupying the display screen, hereinafter referred to as ‘user interface version’, and a Tagged Image File Format (“tiff”) version or a compressed version (‘n’ number of partial images of the tiff version) of the partial image. The ‘1’ in the formula corresponds to the large image formed by combining the plurality of partial images. For example, if a large image may be formed by combining four partial images, then the remote database will store 3(4)+1=13 images to correspond to the large image.

Accordingly, the display screen 600 in FIG. 6A depicts thumbnail versions of the plurality of partial images to the user, whereas FIG. 6B depicts user interface version 604 of partial thumbnail image 604a. The user may then print user interface version 604 of partial image thumbnail 604a by issuing a print command signal to the media processing device.

Providing access to images in a remote database by a media processing device, such as media processing device 102, serves as a convenient and cost effective solution for accessing the images, as it precludes the need to use a data processing device for retrieving and viewing images. Moreover, the media processing device is capable of providing the images, such as schematics, engineering drawings, and maps to users at onsite locations which is especially beneficial for field crews of utilities industries, such as electric power generation industry, working at on-site locations. Furthermore, due to simplicity in accessing the images, the users utilizing the media processing device are not required to be experts in operating the media processing device.

The foregoing description of several methods and an embodiment of the present disclosure have been presented for purposes of illustration. It is not intended to be exhaustive or to limit the present disclosure to the precise steps and/or forms disclosed, and obviously many modifications and variations are possible in light of the above description. It is intended that the scope of the present disclosure be defined by the claims appended hereto.

What is claimed is:

1. A media processing device comprising:
an input module configured to receive an input from a user;
a transceiver module communicably coupled to a remote database for transmitting the input to the remote database and receiving one or more images from the remote database based on the input; and
a user interface module configured to display at least one image of the one or more images to the user.

2. The media processing device of claim 1 further comprising an output module capable of printing the at least one image on a media sheet on receiving a print command signal by the input module from the user.

3. The media processing device of claim 1 further comprising an authentication module configured to authenticate the user based on the input prior to transmission of the input to the remote database by the transceiver module.

4. The media processing device of claim 1 wherein the transceiver module transmits the input to a web service for receiving the one or more images from the remote database, the web service capable of managing access to the remote database.

5. The media processing device of claim 4 wherein the web service is configured to retrieve the one or more images from the remote database based on the input.

6. The media processing device of claim 4 wherein the transceiver module is further configured to
receive at least one memory location of the at least one image from the web service, transmit the at least one memory location to the remote database, and
receive the at least one image from the remote-database based on the at least one memory location.

7. The media processing device of claim 1 wherein the user interface module is configured to display a list of the one or more images prior to displaying the at least one image.

8. The media processing device of claim 7 wherein the input module is further configured to receive a user selection of the at least one image from the list for displaying the at least one image.

9. The media processing device of claim 1 wherein the transceiver module is capable of receiving a plurality of partial images associated with an image of the one or more images from the remote database, wherein the plurality of partial images is stored in the remote database for a size of the image being greater than a pre-defined threshold size.

10. The media processing device of claim 9 wherein the user interface module is configured to
display the plurality of partial images to the user for receiving an image selection of a partial image of the plurality of partial images by the input module, and
display the partial image based on the image selection received from the user.

11. A method for providing access to images in a remote database by a media processing device, the method comprising:
receiving input from a user of the media processing device;
transmitting the input to the remote database;
receiving one or more images from the remote database based on the transmitted input; and
displaying at least one image of the one or more images to the user.

12. The method of claim 11 further comprising printing the at least one image on a media sheet on receiving a print command signal from the user.

13. The method of claim 11 further comprising authenticating the user based on the input prior to transmission of the input to the remote database.

14. The method of claim 11 wherein the input is transmitted to a web service for receiving the one or more images from the remote database, the web service capable of managing access to the remote database.

15. The method of claim 14 wherein the web service is configured to retrieve the one or more images from the remote database based on the input.

16. The method of claim 14 further comprising:
receiving at least one memory location of the at least one image from the web service;
transmitting the at least one memory location to the remote database; and
receiving the at least one image from the remote database based on the at least one memory location.

17. The method of claim 11 further comprising displaying a list of the one or more images to the user prior to displaying the at least one image.

18. The method of claim 17 further comprising receiving a user selection of the at least one image from the list for displaying the at least one image.

19. The method of claim 11 further comprising receiving a plurality of partial images associated with an image of the one or more images from the remote database, wherein the plurality of partial images is stored in the remote database for a size of the image being greater than a pre-defined threshold size.

20. The method of claim 19 further comprising:
displaying the plurality of partial images associated with the image to the user;
receiving an image selection of a partial image of the plurality of partial images from the user; and
displaying the partial image to the user based on the image selection of the partial image.
